(19) United States
(12) Patent Application Publication
(10) Pub. No.: US 2014/0347245 A1
(43) Pub. Date: Nov. 27, 2014

(54) ANTENNA AND WIRELESS MODULE

(71) Applicant: Panasonic Corporation, Osaka (JP)

(72) Inventors: Suguru Fujita, Tokyo (JP); Ryosuke Shiozaki, Kanagawa (JP)

(21) Appl. No.: 14/364,823

(22) PCT Filed: Dec. 14, 2012
(86) PCT No.: PCT/JP2012/008011

§ 371 Date: Jun. 12, 2014

(30) Foreign Application Priority Data
Dec. 28, 2011 (JP) 2011-289196

(51) Int. Cl. H01Q 9/04; H01Q 1/12

(52) U.S. Cl. CPC H01Q 9/0442; H01Q 1/12
USPC 343/878

(57) ABSTRACT

Provided are: an antenna, which makes it easy to change the design of a wireless communication apparatus having the antenna mounted thereon; and a wireless module. The antenna is provided with: an antenna component (130), which is mounted on one surface of a module substrate (110); and an adjustment component (140), which is disposed at a position facing the antenna component (130), said position being on the other surface of the module substrate (110), and which adjusts antenna performance of the antenna component (130). A wireless module (100) can adjust, without changing the whole wireless module (100), characteristics of the antenna component (130) by changing the adjustment component (140) disposed on the module substrate (110).

### TECHNICAL FIELD

The present invention relates to an antenna and a radio module, and more specifically, to a microwave or millimeter wave antenna and a radio module.

### BACKGROUND ART

Patent Literature (hereinafter, abbreviated as PTL) 1 discloses an imaging apparatus including a semiconductor chip mounted on an MMIC (Monolithic Microwave Integrated Circuits) substrate, the semiconductor chip including a high frequency circuit having an oscillator generating a high frequency signal and a patch antenna on a surface of a semiconductor substrate.

PTL 2 discloses a semiconductor device as a radio module using a substrate having an antenna mounted as a passive element and a substrate having a semiconductor element mounted as an active element.

FIG. 1 is a lateral sectional view illustrating a configuration of a semiconductor device including a radio module having electronic components mounted on an MMIC substrate, according to the related art. FIG. 2 is a plane view of the radio module as viewed from the set substrate.

Semiconductor device 1 includes radio module 10 and set substrate 20 for implementing the radio module 10 in FIG. 1 and FIG. 2.

Radio module 10 includes, for example, module substrate 11 including a multilayer substrate with IC interconnections, and frame substrate 12 squarely surrounding the outer circumference of module substrate 11 so as to prevent set substrate 20 from being directly in contact with module substrate 11. Radio module 10 has a cavity structure formed by module substrate 11 and frame substrate 12. Set substrate 20 is a multilayer motherboard and includes internal interconnections (not illustrated).

Frame substrate land 12a as an electrode of frame substrate 12 is soldered onto set substrate 20 and is connected physically and electrically. Module substrate 11 and frame substrate 12 can be thus connected electrically to set substrate 20, which in turn, enables signal transmission.

Pattern-based antenna component 13 is implemented on first surface 11a (upper surface in FIG. 1) of module substrate 11. Antenna component 13 is a patch antenna formed, for example, of an antenna pattern by interconnections.

Module substrate 11 internally includes grand layer (GND) 14 substantially facing antenna component 13 is formed of a ground pattern. Inner layer interconnection 15 and through-via (VIA) 16 are provided inside module substrate 11. VIA 16 electrically connects antenna component 13 with inner layer interconnection 15 and each electronic component.

For example, electronic components including chip component 17, such as resistor R, coil L, and capacitor C, and IC component 18 are mounted on second surface 11b (lower surface in FIG. 1) of module substrate 11. Chip component 17 is electrically connected to second surface 11b through SMT mount solder 17a. IC component 18 has interconnection pad 18a and signal line 18b. Interconnection pad 18a is electrically connected to VIA 16 through Cu core balls 19 as solder plated connection members. Chip component 17 and IC component 18 are connected through signal line 18b.

Inner layer interconnection 15, VIA 16, and Cu core balls 19 serve as a transmission path (signal line) for a signal between antenna component 13 and a radio circuit (for example, IC component 18).

The layer to be buried that includes the components between the substrates is filled with molding resin as a sealing material (not illustrated) for resin sealing. Radio module 10 having a structure formed by stacking the plurality of substrates is thus formed.

### CITATION LIST

### Patent Literature

### PTL 1

### Japanese Patent Application Laid-Open No. 2004-205402

### PTL 2

### Japanese Patent Application Laid-Open No. 2009-266979

### SUMMARY OF INVENTION

### Technical Problem

The radio module according to the related art, however, has a problem in that it is difficult to change the design of the module once radio module 10, which has the structure illustrated in FIG. 1, has been designed. More specifically, it is hard to change the placement of antenna component 13 mounted on first surface 11a of module substrate 11 and the electronic components mounted on second surface 11b in radio module 10.

In radio module 10, the characteristics of antenna component 13 change with not only the placement of antenna component 13 and the electronic components but also the shape of a housing used for set substrate 20 or the shape of set substrate 20. For this reason, radio communication apparatuses including an antenna require optimization of the characteristics of antenna component 13 for each model, i.e., redesigning the radio module for each model.

It is an object of the present invention to provide an antenna and a radio module that make it easier to change the design of a radio communication apparatus including the antenna.

### Solution to Problem

An antenna according to an aspect of the present invention includes: an antenna component that is mounted on one of surfaces of a module substrate; and an adjustment component that is placed at a position opposite to and corresponding to the antenna component on another one of the surfaces of the module substrate.

A radio module according to an aspect of the present invention includes the antenna described above.

### Advantageous Effects of Invention

According to the present invention, an antenna and a radio module that minimize changes in component design and that make it easier to change a design.

### BRIEF DESCRIPTION OF DRAWINGS

FIG. 1 is a lateral sectional view illustrating a configuration of a semiconductor device including a radio module having electronic components mounted on an MMIC substrate, according to the related art;

FIG. 2 is a plane view of the radio module according to the related art as viewed from a set substrate;

FIG. 3 is a lateral sectional view illustrating a configuration of a semiconductor device including a radio module according to Embodiment 1 of the present invention;

FIG. 4 is a plane view of the radio module according to Embodiment 1 as viewed from a set substrate;

FIG. 5 is a perspective view illustrating the placement of an antenna component in the radio module according to Embodiment 1;

FIG. 6 is a sectional view of the main portion of a radio module according to Embodiment 2 of the present invention;

FIG. 7 is a sectional view of the main portion of the radio module according to Embodiment 2;

FIG. 8 is a sectional view illustrating the main portion of another configuration of an adjustment component of the radio module according to Embodiment 2;

FIG. 9 is a sectional view illustrating the main portion of an adjustment component of a radio module according to Embodiment 3 of the present invention with respect to attachment for the adjustment component;

FIG. 10 illustrates how the adjustment component and the chip component of the radio module according to Embodiment 4 of the present invention are attached;

FIGS. 11A and 11B illustrate a configuration of an adjustment component of a radio module according to Embodiment 5 of the present invention;

FIGS. 12A and 12B illustrate configurations of a module substrate and an adjustment component of a radio module according to Embodiment 6 of the present invention;

FIGS. 13A and 13B illustrate configurations of a module substrate and an adjustment component of a radio module according to Embodiment 7 of the present invention;

FIGS. 14A and 14B illustrate configurations of a module substrate and an adjustment component of a radio module according to Embodiment 8 of the present invention; and

FIG. 15 is a plane view of a radio module according to Embodiment 9 of the present invention as viewed from a set substrate.

### DESCRIPTION OF EMBODIMENTS

Hereinafter, embodiments of the present invention will be described in detail with reference to the accompanying drawings.

### Embodiment 1

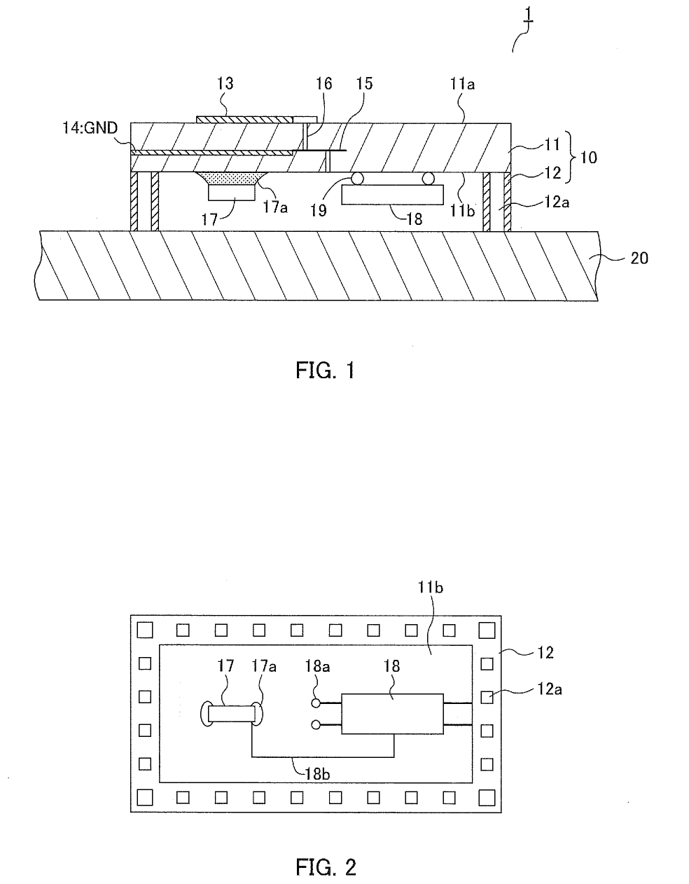

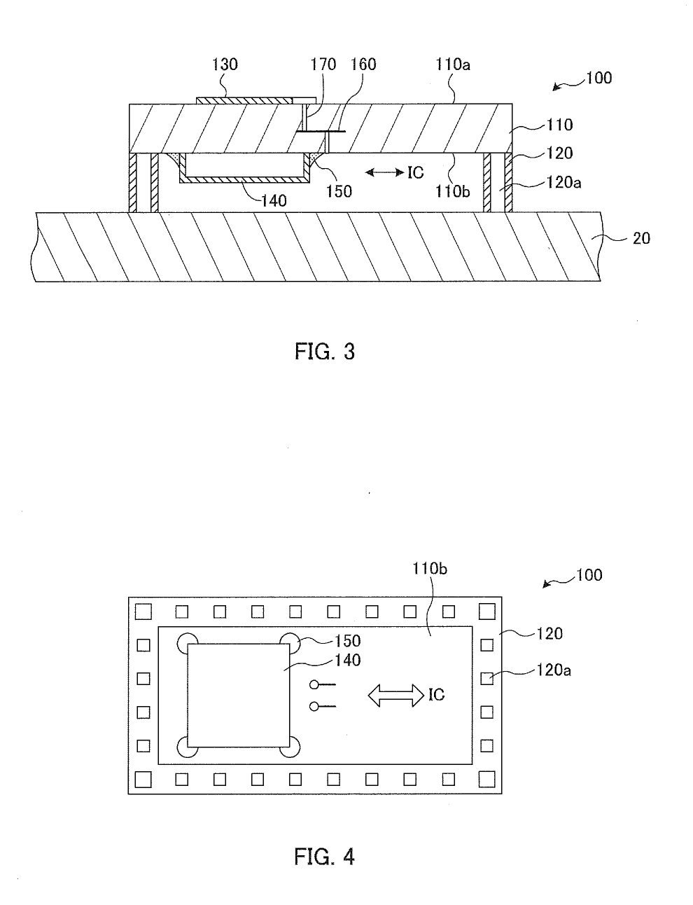

FIG. 3 is a lateral sectional view illustrating a configuration of a semiconductor device including a radio module according to Embodiment 1 of the present invention. FIG. 4 is a transparent plane view of the radio module as viewed from a set substrate through a frame substrate. The same elements as those in FIG. 1 are denoted by the same reference numerals.

The present embodiment is an example given by applying the antenna of the present invention, for example, to a semiconductor device used for radio communication.

In FIG. 3 and FIG. 4, the semiconductor device according to the present embodiment includes radio module 100 and set substrate 20 for mounting radio module 100.

Radio module 100 includes, for example, module substrate 110 including a multilayer substrate with IC interconnections, and frame substrate 120 squarely surrounding the outer circumference of module substrate 110 so as to prevent set substrate 20 from being directly in contact with module substrate 110. Radio module 100 has a cavity structure formed by module substrate 110 and frame substrate 120. Set substrate 20 is a multilayer motherboard and includes internal interconnections (not illustrated).

Frame substrate land 120a serving as an electrode of frame substrate 120 is soldered onto set substrate 20 and is connected physically and electrically. Module substrate 110 and frame substrate 120 can be thus connected electrically to set substrate 20, which in turn, enables signal transmission.

Pattern-based antenna component (antenna element) 130 is implemented on first surface 110a (upper surface in FIG. 3) of module substrate 110. Antenna component 130 is a patch antenna formed, for example, of an antenna pattern by interconnections.

Adjustment component 140 for adjusting the antenna performance of antenna component 130 is placed on second surface 110b (lower surface in FIG. 3) of module substrate 110 at a position opposite to and corresponding to the position of antenna component 130 and apart from second surface 110b by a predetermined distance but in parallel to second surface 110b. Adjustment component 140 is a GND electrode paired with antenna component 130. Adjustment component 140 is fixed on second surface 110b of module substrate 110, for example by solder mounting land 150. Antenna component 130 and adjustment component 140 constitute an entire antenna.

In addition, no ground layer (GND) is formed inside of module substrate 110 in the present embodiment. Moreover, a predetermined dielectric other than air may be provided between adjustment component 140 and second surface 110b.

Note that, adjustment component 140 is a GND electrode serving as GND for antenna component 130 and is placed at a position apart from second surface 110b by a predetermined distance. Therefore, the dielectric constant of module substrate 110 and the dielectric constant of adjustment component 140 exist between antenna component 130 and adjustment component 140. Dielectric constant ∈ after the implementation is found by Equation 1 below where dielectric constant is ∈₁ and thickness is H₁ between antenna component 130 and second surface 110b, and dielectric constant is ∈₂ and thickness is H₂ between second surface 110b and adjustment component 140.

∈=(∈₁×H₁+∈₂×H₂)/(H₁+H₂) (Equation 1)

Based on Equation 1, a dielectric that can be placed inside adjustment component 140 is changed to vary dielectric constant ∈ considered from entire antenna component 130, i.e., calculated from antenna component 130 side.

Inner layer interconnection 160 and through-via (VIA) 170 are provided inside of module substrate 110. VIA 170 electrically connects antenna component 130 with inner layer interconnection 160 and each electronic component.

For example, electronic components (not illustrated) including chip components, such as resistor R, coil L, and capacitor C, and an IC component are mounted on second surface 110b (lower surface in FIG. 3) of module substrate 110. The chip components are electrically connected to second surface 110b, for example, through SMT mounting solder.

The layer to be buried that includes the components between the substrates is filled with molding resin as a sealing material (not illustrated) for resin sealing. Radio module 100 having a structure formed by stacking the plurality of substrates is thus formed.

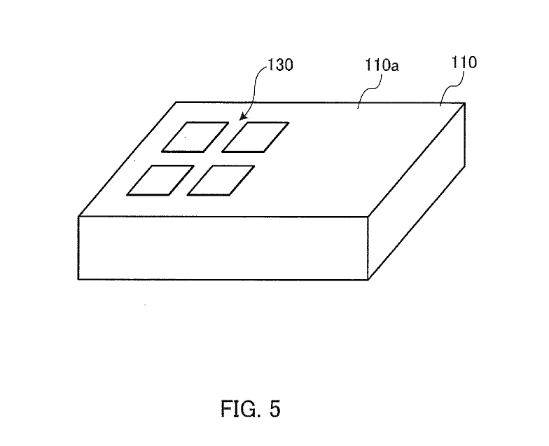

FIG. 5 is a perspective view illustrating the placement of antenna component 130 in radio module 100.

In FIG. 5, antenna component 130 has a 2×2 array configuration on first surface 110a of module substrate 110. Antenna component 130 has the 2×2 array configuration as an example, and may have one or more patterns arranged in a grid shape. More favorable antenna characteristics are acquired by arranging more patterns.

A high frequency signal is vertically emitted from antenna component 130 having an array configuration to set substrate 20 as a substantially collimated beam.

Radio module 100 configured in the manner described above will be explained.

Radio module 100 includes adjustment component 140 serving as a GND electrode paired with antenna component 130, instead of a ground layer (GND) inside of the module substrate according to the related art. Adjustment component 140 can be placed at variable distance (thickness) d between the GND electrode and second surface 110b of module substrate 110. A dielectric other than air is also provided between the GND electrode and second surface 110b of module substrate 110 to thereby vary dielectric constant ∈.

Thereby, radio module 100 can adjust the characteristics of antenna component 130 by making a change in adjustment component 140 placed on module substrate 110, without changing the whole of radio module 100. More specifically, radio module 100 can correspond to a change in specification of a radio communication apparatus including an antenna, for example, without redesigning module substrate 110.

As explained in detail above, the antenna of the present embodiment includes antenna component 130 mounted on one of surfaces of module substrate 110, and adjustment component 140 placed at the position opposite to and corresponding to antenna component 130 on the other surface of module substrate 110.

This configuration enables adjustment of the characteristics of antenna component 130 by changing adjustment component 140, which is to be mounted after antenna component 130. Accordingly, it is possible to minimize changes in component design and thus to correspond to a change in specification of a radio communication apparatus including an antenna, for example, without redesigning module substrate 110.

### Embodiment 2

Embodiment 1 has been described with an example where adjustment component 140, which is the GND electrode paired with antenna component 130, is attached at the position in parallel and equivalent to antenna component 130 in the lateral direction.

Embodiment 2 will be described with an example where adjustment component 140 is attached at a position shifted relative to antenna component 130.

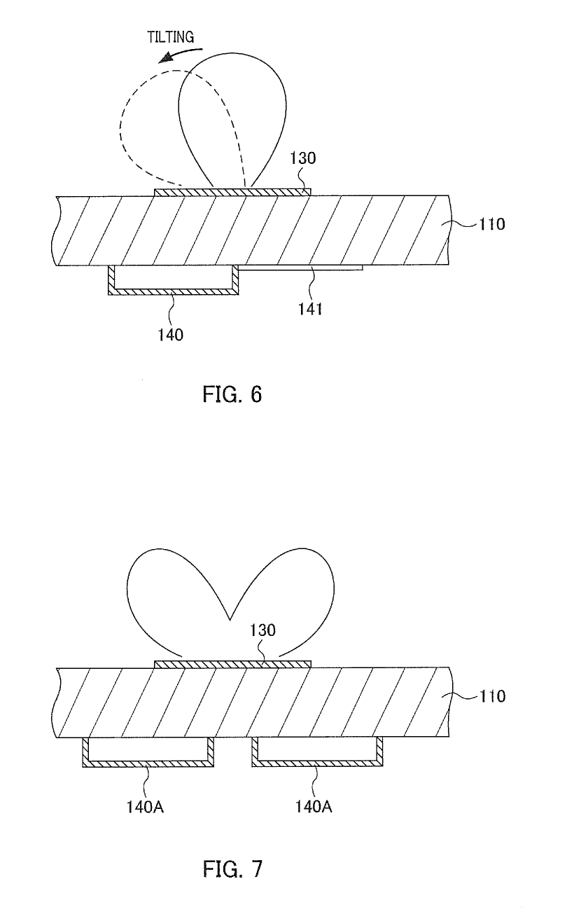

FIG. 6 is a sectional view of the main portion of a radio module according to Embodiment 2 of the present invention. FIG. 6 illustrates the positional relationship between antenna component 130 and adjustment component 140, and the antenna directivity.

In FIG. 6, adjustment component 140 is placed at a position shifted relative to antenna component 130 in order to cover a part of antenna component 130. In FIG. 6, adjustment component 140 is placed at the left of antenna component 130.

More specifically, adjustment component 140 is placed so as to cover ¼ or ½ of the element in the 2×2 array configuration illustrated in FIG. 5. Adjustment component 140 can be placed at any position by connecting GND interconnection 141 to adjustment component 140. In FIG. 6, adjustment component 140 is placed at the left of antenna component 130 to thereby enable the beam tilting of the antenna directivity toward the left as indicated by a dashed line in FIG. 6.

FIG. 7 is a sectional view of the main portion of another radio module according to Embodiment 2 of the present invention. FIG. 7 illustrates the positional relationship between antenna component 130 and adjustment components 140A, and the antenna directivity.

In FIG. 7, adjustment components 140A are placed while being shifted respectively toward the ends of antenna component 130 relative to the center of antenna component 130, so as to cover the respective ends of antenna component 130 (placed at both the right and left of antenna component 130 in FIG. 7). More specifically, adjustment components 140A are placed so as to cover ¼ or ½ of the element in the lateral direction in the 2×2 array configuration illustrated in FIG. 5. As illustrated in FIG. 7, adjustment components 140A are placed at the ends of antenna component 130, respectively, to provide wide antenna directivity.

Heretofore, the method to change the antenna directivity by changing the pattern of an antenna component or changing the dielectric constant between the antenna component and the GND has been generally used. The present embodiment has an advantageous effect in that it is possible to change the antenna directivity without changing the pattern or the dielectric constant of the antenna component. This advantageous effect makes it possible to increase the degree of freedom in design of a radio communication apparatus including an antenna.

(Variation 1)

FIG. 6 and FIG. 7 illustrate an example where the antenna directivity is caused to tilt or increase in width by placing adjustment component(s) 140 at a position shifted relative to antenna component 130. Instead of employing the configuration in which adjustment component 140 is shifted, the configuration of the adjustment component may be changed.

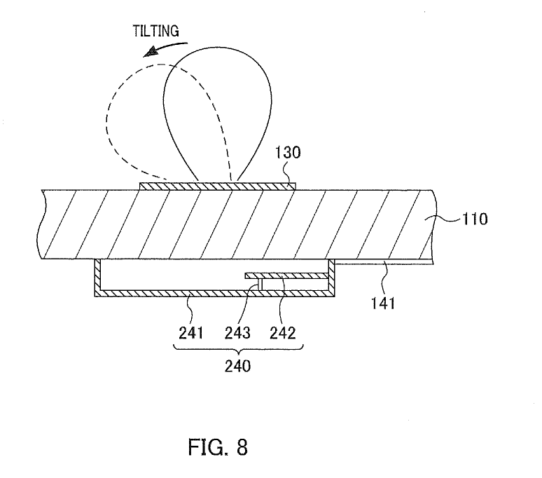

FIG. 8 is a sectional view illustrating the main portion of another configuration of the adjustment component of the radio module according to Embodiment 2. The same elements as those in FIG. 6 are denoted by the same reference numerals.

In FIG. 8, adjustment component 240 has a multilayer structure including GND electrode 241, GND electrode 242 configured by internal interconnection, and through-via (VIA) 243 electrically connecting GND electrode 241 and GND electrode 242.

Internal GND electrode 242 configured by internal interconnection is located between GND electrode 241 and module substrate 110, and is placed eccentrically from the center of antenna component 130 (placed at the right of antenna component 130 in FIG. 8).

With this configuration, a part of GND electrodes 241 is covered with internal GND electrode 242 configured by internal interconnection, which in turn, provides an advantageous effect equivalent to that obtained by placement of adjustment component 240 at a position shifted relative to antenna component 130. In FIG. 8, adjustment component 240 is placed at the left of antenna component 130.

Accordingly, it is possible to obtain an advantageous effect similar to that obtained in a case where adjustment component 140 in FIG. 6 is placed at a position shifted relative to antenna component 130.

Moreover, adjustment component 240 enables finer adjustment than placement of adjustment component 140 at a position shifted relative to antenna component 130. Radio module 100 used in the present embodiment is assumed to be applied to a millimeter wave or microwave. For example, precision required for the thickness of module substrate 110 is negligible in a microwave in a 2 GHz band. However, in a millimeter wave in a 60 GHz band having an approximately ten times difference in a frequency from a microwave in a 2 GHz band, precision required for the thickness (namely, in units of μm) is considered a problem.

As an example, radio module 100 has a side length of about 10 mm, the element of antenna component 130 has a size of about 1.2 mm, adjustment component 240 has a width of about 3 mm, and the thickness from second surface 110b of module substrate 110 to GND electrode 242 configured by the internal interconnection is 20 to 40 μm. It is difficult to enable such fine positional alignment without using adjustment component 240 based on a multilayer structure. Adjustment component 240 may also be applied to the adjustment method in FIG. 6 and FIG. 7.

### Embodiment 3

In Embodiments 1 and 2, adjustment components 140 and 240 are attached to second surface 110b of module substrate 110 using soldering of the SMT (surface mount technology) component, for example.

Embodiment 3 will be described with an example where adjustment components 140 and 240 are attached to second surface 110b of module substrate 110 using solder balls.

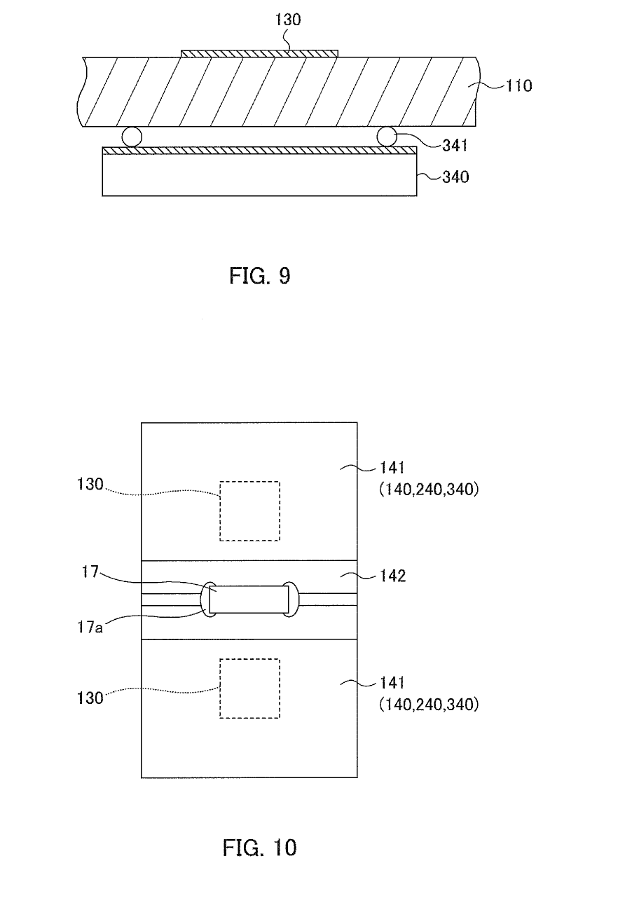

FIG. 9 is a sectional view illustrating the main portion of an adjustment component of a radio module according to Embodiment 3 of the present invention with respect to attachment for the adjustment component.

In FIG. 9, adjustment component 340 is attached to second surface 110b of module substrate 110 using solder balls 341. Solder balls 341 are, for example, Cu core balls serving as solder plated connection members. The diameter of the Cu core ball is determined according to dielectric constant c after the implementation represented in Equation 1, and is set to, for example, 20 to 50 [μm].

Adjustment component 340 is accurately attached to second surface 110b of module substrate 110 using solder balls 341 similarly to an IC component.

As long as adjustment component 340 is accurately attached to second surface 110b of module substrate 110, for example, bumps may be used in place of the core balls. Attachment with accuracy in units of 1˜2 [μm] is possible using bumps.

### Embodiment 4

Embodiment 4 will be described in regard to placement of an adjustment component and a chip component.

FIG. 10 illustrates attachment of the adjustment component and the chip component of the radio module according to Embodiment 4 of the present invention.

In FIG. 10, adjustment component 140 (240 or 340) is provided at a position opposite to and corresponding to antenna component 130 on first surface 110a of module substrate 110. The GND electrode of adjustment component 140 (240 or 340) has a larger area than antenna component 130 provided on the antenna implementation surface. Thus, the antenna characteristics can be adjusted more favorably.

In the example illustrated in FIG. 5, antenna component 130 has a 22 array configuration on first surface 110a of module substrate 110. For this reason, the GND electrode of adjustment component 140 (240 or 340) is placed corresponding to each element of the 2×2 array configuration.

Accordingly, the loss of electric power transmitted or received by antenna component 130 can be minimized, and a radio wave can be transmitted or received favorably. This placement of antenna component 130 and adjustment component 140 (240 or 340) is only an example, and more patterns may be arranged in a grid shape. More favorable antenna characteristics are acquired by arranging more patterns.

Chip component 17 is placed with interconnection on adjustment component 140 (240 or 340), for example, on flat surface 142 between GND electrodes 141 other than GND electrodes 141 of adjustment component 140 (240 or 340). Placement of the chip component in a region other than GND electrodes 141 does not affect the antenna performance and can enhance the packaging density.

### Embodiment 5

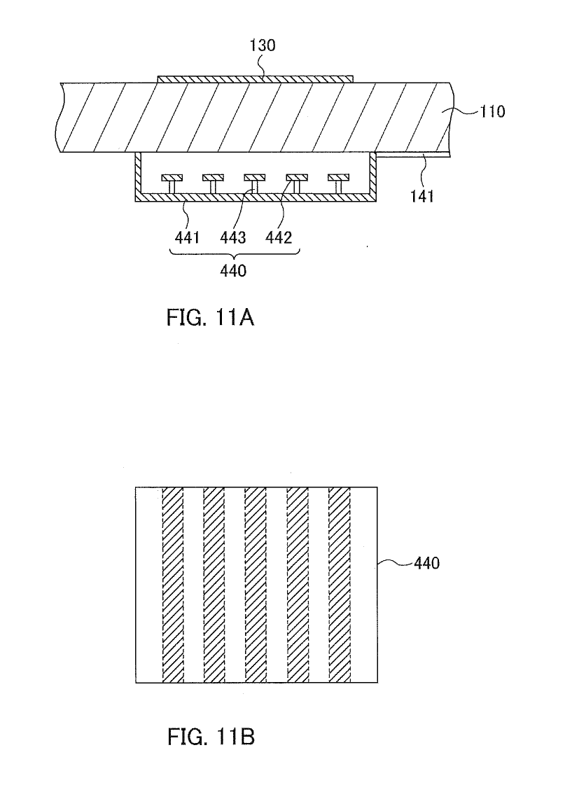

FIGS. 11A and 11B illustrate a configuration of an adjustment component of a radio module according to Embodiment 5 of the present invention. FIG. 11A is a sectional view illustrating the main portion of a configuration of the adjustment component. FIG. 11B is a plane view of the adjustment component viewed from an antenna component. The same elements as those in FIG. 8 are denoted by the same reference numerals.

In FIGS. 11A and 11B, adjustment component 440 has a multilayer structure including GND electrode 441, internal GND electrode 442 configured by internal interconnection, and through-via (VIA) 443 electrically connecting internal GND electrodes 442.

A plurality of internal GND electrodes 442 (five electrodes in FIGS. 11A and 11B) are located between GND electrode 441 and module substrate 110, and are aligned at predetermined intervals.

With this configuration, in adjustment component 440, GND electrode 441 partially and periodically covered by internal GND electrodes 442. As indicated by hatching in FIG. 11B, the GND is provided in a periodic structure as viewed from antenna component 130 side. With this the periodic structure of the GND, antenna component 130 has GND electrode 441 having a substantially small area, but GND electrode 441 virtually having wide characteristics is provided. Thus, downsizing of adjustment component 440 is made possible.

However, strictly speaking, adjustment component 440 downsized by employing the periodic structure described above has antenna performance that is not equivalent to the antenna performance of an adjustment component not having the above-described periodic structure. In considering that radio module 100 has a side length of about 10 mm, however, downsizing of adjustment component 440 can provide a large advantageous effect for implementation. According to the experiment conducted by the present inventors, an advantageous effect of downsizing an adjustment component (having a side length of about 3 mm) without the above-described periodic structure by about 20 to 30 percent in length was obtained.

### Embodiment 6

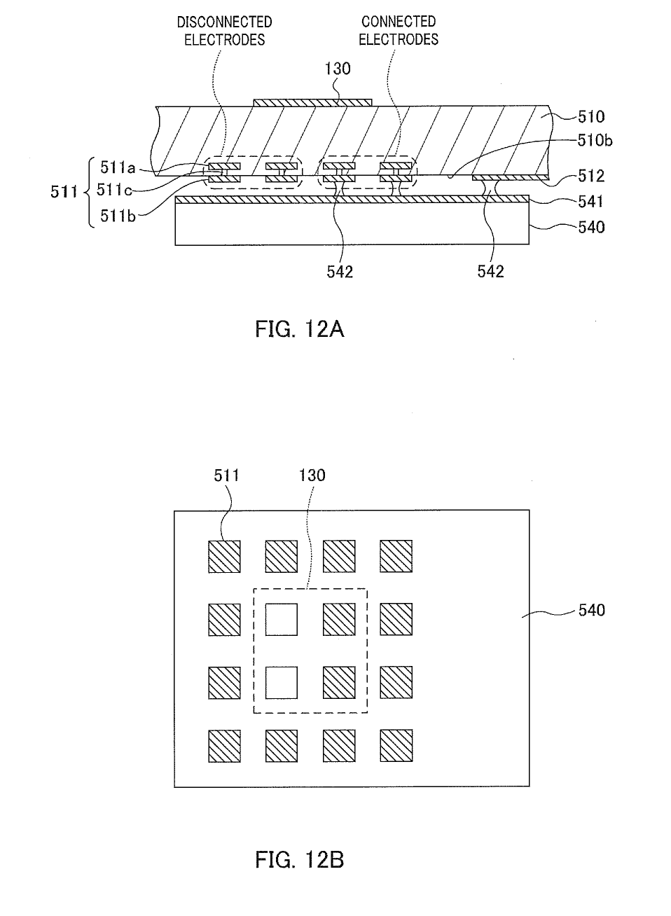

FIGS. 12A and 12B illustrate configurations of a module substrate and an adjustment component of a radio module according to Embodiment 6 of the present invention. FIG. 12A is a sectional view illustrating the main portion of configurations of the module substrate and the adjustment component. FIG. 12B is a plane view of the adjustment component viewed from an antenna component. The same elements as those in FIG. 8 are denoted by the same reference numerals.

In FIG. 12A, module substrate 510 including a multilayer substrate includes a plurality of electrodes 511 and ground wire 512 on second surface 510b (lower surface in FIG. 12A).

Independent electrodes 511 are arranged in a matrix. Electrode 511 includes internal electrode 511a formed inside of module substrate 510, external electrode 511b exposed from the surface of second surface 510b, and through-via (VIA) 511c connecting internal electrode 511a and external electrode 511b.

In FIG. 12A, adjustment component 540 includes GND electrode 541 and is electrically connected via solder 542 to the plurality of electrodes 511 and ground wire 512 which are formed on module substrate 510. More specifically, GND electrode 541 of adjustment component 540 is selectively connected to a predetermined electrode 511 among the plurality of electrodes 511 formed in module substrate 510.

In FIG. 12, GND electrode 541 of adjustment component 540 is not connected to two left electrodes 511 among electrodes 511 at the positions opposite to and corresponding to antenna component 130 (see white squares in FIG. 12B).

With this configuration, electrode 511 (see white squares in FIG. 12B) not connected to GND electrode 541 of adjustment component 540 does not serve as the GND for antenna component 130. This configuration apparently allows for adjustment of the distance (thickness) between antenna component 130 and GND electrode 541 of adjustment component 540.

Additionally, the configuration enabling selective connection of electrodes 511 using module substrate 510 and adjustment component 540 according to the present embodiment allows for adjustment of the distance (thickness) between antenna component 130 and GND electrode 541 of adjustment component 540 similarly to adjustment component 240 having the multilayer structure in FIG. 8.

According to the present embodiment, module substrate 510 is beforehand provided with electrodes 511 connectable to adjustment component 540, so that the antenna performance can be adjusted as appropriate. Thus, it is made possible to correspond to a change in specification of a radio communication apparatus including an antenna, for example, without redesigning module substrate 510.

### Embodiment 7

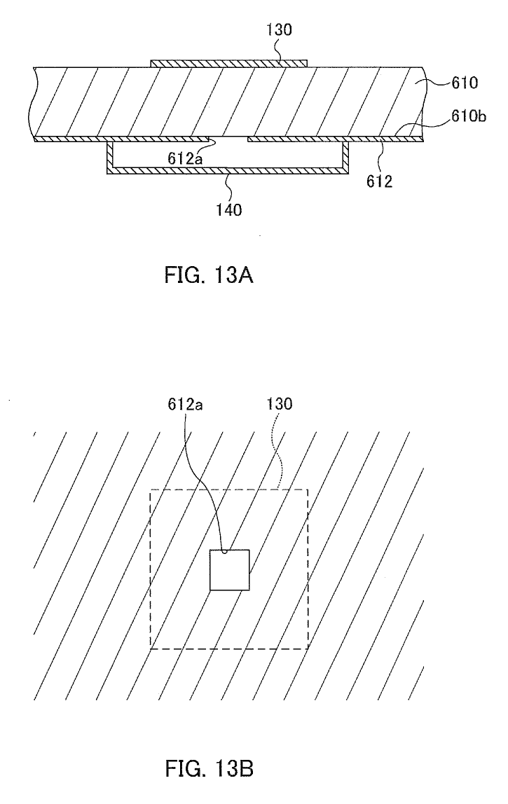

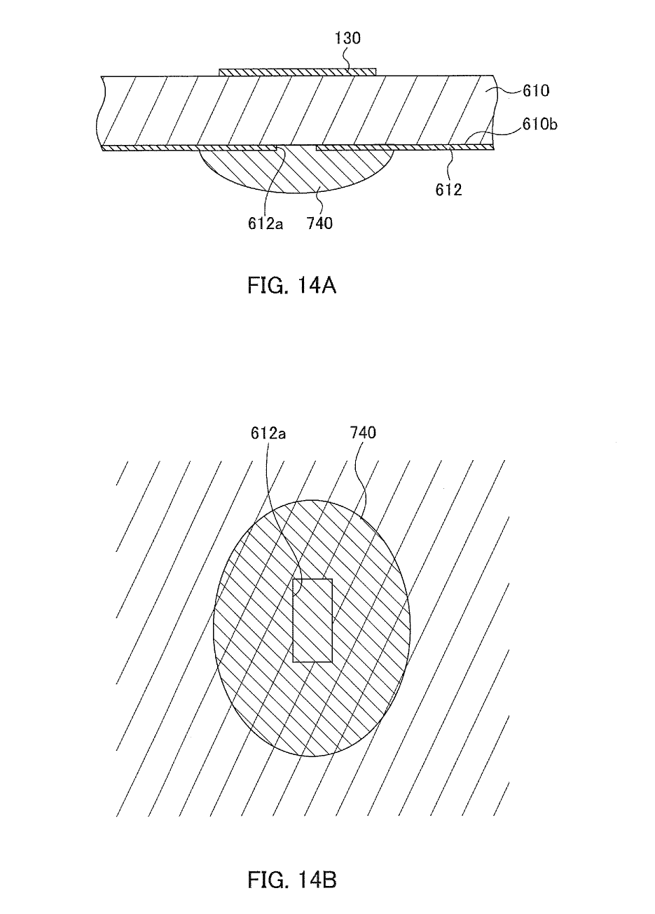

FIGS. 13A and 13B illustrate configurations of a module substrate and an adjustment component of a radio module according to Embodiment 7 of the present invention. FIG. 13A is a sectional view illustrating the main portion of configurations of the module substrate and the adjustment component. FIG. 13B is a transparent plane view of GND electrode 612 for the adjustment component of module substrate 610, viewed from an antenna component. The same elements as those in FIGS. 3 and 8 are denoted by the same reference numerals.

In FIG. 13A, module substrate 610 including a multilayer substrate includes GND electrode 612 on second surface 610b (lower surface in FIG. 13A). GND electrode 612 has GND electrode removal portion 612a as an opening. In FIGS. 13A and 13B, GND electrode removal portion 612a is opened in a square shape at the position opposite to and corresponding to the center of antenna component 130, but the position, shape, and number of GND electrode removal portions 612a are not limited to this case.

With this configuration, a region other than GND electrode removal portion 612a (see white squares in FIG. 13B) does not serve as GND for antenna component 130. This can more finely adjust the distance (thickness) of adjustment component 140 including antenna component 130 and the GND electrode. For example, in adjustment component 140 having a thickness of 0.2 [μm] and a dielectric constants of 4, the thickness or dielectric constant ∈ can be changed for improvement in the antenna performance of antenna component 130 by 5%, but such a change needs precise adjustment. For example, even if such a change is possible by increasing the thickness from 0.2 [μm] to 0.9 [μm], it may be difficult to make such a change depending on relationships with other components or the height relative to the substrate.

According to the present embodiment, module substrate 610 includes GND electrode 612, and GND electrode removal portion 612a having a predetermined size is opened in GND electrode 612, so that the antenna performance can be adjusted as appropriate. Thus, it is made possible to correspond to a change in specification of a radio communication apparatus including an antenna, for example, without redesigning module substrate 610.

### Embodiment 8

FIGS. 14A and 14B illustrate configurations of a module substrate and an adjustment component of a radio module according to Embodiment 8 of the present invention. FIG. 14A is a sectional view illustrating the main portion of configurations of the module substrate and the adjustment component. FIG. 14B is a transparent plane view of GND electrode 612 for the adjustment component of module substrate 610, viewed from an antenna component. The same elements as those in FIGS. 13A and 13B are denoted by the same reference numerals.

In FIG. 14A, module substrate 610 including a multilayer substrate includes GND electrode 612 on second surface 610b (lower surface in FIG. 14A). GND electrode 612 has GND electrode removal portion 612a as an opening. In FIGS. 14A and 14B, GND electrode removal portion 612a is opened in a rectangular shape at the position opposite to and corresponding to the center of antenna component 130, but the position, shape, and number of GND electrode removal portions 612a are not limited to this case.

The adjustment component in each of the embodiments has a GND electrode, but adjustment component 740 according to the present embodiment is formed of resin. Adjustment component 740 formed of resin is attached to GND electrode removal portion 612a on second surface 610b to change a dielectric constant, for example, from ∈=1 (air) to ∈=4 (resin). This configuration allows for changing the whole dielectric constant viewed from antenna component 130, i.e., a dielectric constant calculated from antenna component 130. For example, it is possible to change the antenna performance without redesigning module substrate 610.

### Embodiment 9

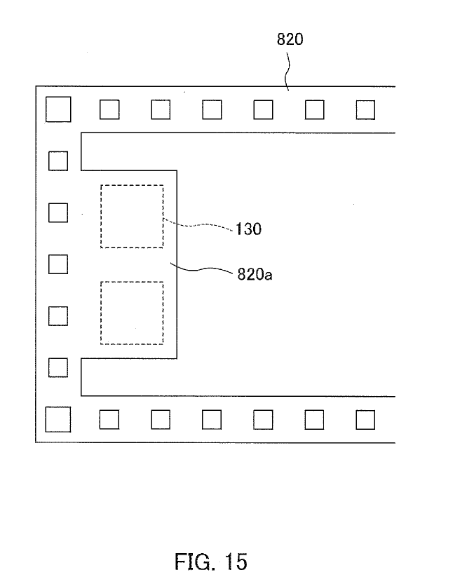

FIG. 15 is a transparent plane view of frame substrate 820 in a radio module according to the embodiment 9 of the present invention, as viewed from a set substrate.

In FIG. 15, frame substrate 820 includes adjustment component portion 820a. Adjustment component portion 820a corresponds to adjustment components 140, 140A, 240, 340, 440, and 540 in the above-described embodiments. That is, frame substrate 820 is formed by integrating the frame substrate with the adjustment component.

According to the present embodiment, since adjustment component portion 820a is integrated with frame substrate 820, the clearance between the module substrate and the adjustment component can be secured more precisely than the above-described embodiments for individually mounting the adjustment component on the module substrate.

The description above is provided only to describe preferred embodiments of the present invention, and the scope of the invention is not limited to this description.

In the above-described embodiments, the terms “antenna,” “antenna component,” and “radio module” are used for convenience of the explanation. For this reason, it is also possible to use the terms such as an “antenna element” and a “semiconductor device” may be used.

Moreover, the type, connection method, and number of the antenna elements forming the antenna component and the adjustment components are not limited to the above-described embodiments.

The disclosure of Japanese Patent Application No. 2011-289196, filed on Dec. 28, 2011, including the specification, drawings and abstract, is incorporated herein by reference in its entirety.

### INDUSTRIAL APPLICABILITY

The antenna and radio module according to the present invention are useful as an antenna and a radio module that minimize changes in component design and that make it easier to change a design.

### REFERENCE SIGNS LIST

100 Radio module
110, 510, 610 Module substrates
110a First surface
110b Second surface
120, 820 Frame substrates
130 Antenna component
140, 140A, 240, 340, 440, 540, 740 Adjustment components
141, 241, 242, 441 GND Electrodes
341 Solder balls
442 Internal GND electrode
820a Adjustment component portion

1. An antenna comprising:
an antenna component that is mounted on one of surfaces of a module substrate; and
an adjustment component that is placed at a position opposite to and corresponding to the antenna component on another one of the surfaces of the module substrate.

2. The antenna according to claim 1, wherein the adjustment component is a GND electrode or resin.

3. The antenna according to claim 1, wherein the adjustment component is attached at a position apart from the other one of the surfaces of the module substrate by a predetermined distance.

4. The antenna according to claim 1, wherein the adjustment component is attached to the other one of the surface of the module substrate using a surface mount technology (SMT) component including a solder ball.

5. The antenna according to claim 1, wherein the adjustment component is attached eccentrically from a center portion of the antenna component.

6. The antenna according to claim 1, wherein the adjustment component includes a GND electrode, and a predetermined dielectric between the other one of the surfaces of the module substrate and the GND electrode.

7. The antenna according to claim 1, wherein the adjustment component includes a multilayer structure including a GND electrode and an internal GND electrode that includes an internal interconnection which covers a part of the GND electrode.

8. The antenna according to claim 7, wherein the internal GND electrode includes a plurality of electrodes that have a periodic structure with respect to the GND electrode.

9. The antenna according to claim 1, further comprising a plurality of electrodes placed on the other one of the surfaces of the module substrate, wherein:
the adjustment component includes a GND electrode; and
a predetermined electrode of the plurality of electrodes placed on the other one of the surfaces of the module substrate is electrically connected to the GND electrode.

10. The antenna according to claim 1, further comprising a GND electrode placed on the other one of the surfaces of the module substrate, wherein
the GND electrode includes a GND electrode removal portion that is an opening at a position opposite to and corresponding to the adjustment component.

11. The antenna according to claim 1, further comprising a frame substrate that surrounds the module substrate, wherein
the frame substrate is integrally formed with the adjustment component.

12. A radio module comprising the antenna according to claim 1.
